(19) United States
(12) Patent Application Publication
(10) Pub. No.: US 2025/0123372 A1
(43) Pub. Date: Apr. 17, 2025

(54) IMAGE SENSING DEVICE

(71) Applicant: SK hynix Inc., Gyeonggi-do (KR)

(72) Inventors: Eun Chang LEE, Gyeonggi-do (KR); Min Kyu KIM, Gyeonggi-do (KR); Jin Seon KIM, Gyeonggi-do (KR); Hak Soon KIM, Gyeonggi-do (KR); Da Hwan PARK, Gyeonggi-do (KR); Min Seok SHIN, Gyeonggi-do (KR); Hoo Chan LEE, Gyeonggi-do (KR)

(21) Appl. No.: 18/624,126

(22) Filed: Apr. 2, 2024

(30) Foreign Application Priority Data
Oct. 11, 2023 (KR) 10-2023-0134953

(51) Int. Cl. G01S 7/4863; G01S 17/894; H04N 25/78

(52) U.S. Cl. CPC G01S 7/4863; G01S 17/894; H04N 25/78

(57) ABSTRACT

An image sensing device capable of detecting a distance to a target object according to a time-of-flight (TOF) method is disclosed. The image sensing device includes a plurality of light receiving elements each configured to generate a sensing voltage corresponding to a current pulse based on a photon reflected from a target object; a plurality of quenching circuits corresponding to the respective light receiving elements and each configured to output a pixel signal by controlling the sensing voltage from a corresponding light receiving element of the light receiving elements, and a readout circuit shared by the plurality of quenching circuits and configured to generate a readout signal by controlling a delay time of the pixel signal.

### CROSS-REFERENCE TO RELATED APPLICATION

This patent application claims priority and benefits of Korean patent application No. 10-2023-0134953, filed on Oct. 11, 2023, which is herein incorporated by reference in its entirety.

### TECHNICAL FIELD

Embodiments of the present disclosure generally relate to an image sensing device capable of detecting a distance to a target object according to a time-of-flight (TOF) method.

### BACKGROUND

Recently, Time of Flight (TOF) technology, which has been in the spotlight, emits pulse-shaped light from a light source located within or near a sensor to a target object, receives light reflected from the target object, calculates a round trip time using emitted light and reflected light, and measures the distance to the target object using the calculated round trip time according to the principle of constancy of light velocity. To precisely measure the TOF, since a reaction must occur as soon as light reaches a light receiving element, photoelectric conversion elements with very high sensitivity are required for TOF technology. To this end, research on single-photon avalanche diodes (SPADs) which can be manufactured by CMOS fabrication technology has been actively conducted.

However, as high-resolution TOF technology is developed, a single-photon avalanche diode (SPAD) element gradually becomes smaller in size, and there may be restrictions on the area of a quenching circuit that processes the output of the SPAD element. Additionally, as the number of SPAD elements increases, the number of output circuits and the number of interconnect lines (or wirings) increase, resulting in an increased chip area.

### SUMMARY

In accordance with an embodiment of the present disclosure, an image sensing device may include a plurality of light receiving elements each configured to generate a sensing voltage corresponding to a current pulse based on a photon reflected from a target object; a plurality of quenching circuits corresponding to the respective light receiving elements and each configured to output a pixel signal by controlling the sensing voltage from a corresponding light receiving element of the light receiving elements; and a readout circuit shared by the plurality of quenching circuits and configured to generate a readout signal by controlling a delay time of the pixel signal.

In accordance with another embodiment of the present disclosure, an image sensing device may include a circuit chip, and a sensor chip stacked on an upper portion of the circuit chip. The sensor chip may include a plurality of light receiving elements each configured to generate a current pulse by detecting a single photon reflected from a target object. The circuit chip may include a plurality of quenching circuits corresponding to the plurality of light receiving elements and configured to output a plurality of pixel signals by controlling sensing voltages corresponding to the current pulses, respectively, and a readout circuit shared by the plurality of quenching circuits and configured to generate a readout signal by reading out the plurality of pixel signals.

### BRIEF DESCRIPTION OF THE DRAWINGS

The above and other features and beneficial aspects of the disclosed technology will become readily apparent with reference to the following detailed description when considered in conjunction with the accompanying drawings.

FIG. 1 is a schematic diagram illustrating an imaging device based on some embodiments of the present disclosure.

FIG. 2 is a detailed circuit diagram illustrating a pixel array

of the image sensing device shown in FIG. 1 based on some embodiments of the present disclosure.

FIG. 3 is a diagram illustrating a structure of the pixel array shown in FIG. 2 based on some embodiments of the present disclosure.

FIG. 4 is a timing diagram illustrating operations of a

quenching circuit shown in FIG. 2 based on some embodiments of the present disclosure.

FIG. 5 is a detailed circuit diagram illustrating a readout circuit of the image sensing device shown in FIG. 1 based on some embodiments of the present disclosure.

FIG. 6 is a timing diagram illustrating operations of the readout circuit shown in FIG. 5 based on some embodiments of the present disclosure.

FIG. 7 is a diagram illustrating a stacked structure of the image sensing device shown in FIG. 1 based on some embodiments of the present disclosure.

FIG. 8 is a diagram illustrating a logic array included in a circuit chip shown in FIG. 7 based on some embodiments of the present disclosure.

FIG. 9 is a schematic diagram illustrating an arrangement structure of a macro array and a readout circuit within the circuit chip shown in FIGS. 7 and 8.

FIG. 10 is a diagram illustrating a routing structure of a single-photon avalanche diode (SPAD) device shown in FIG. 7 and a macro cell shown in FIG. 9 based on some embodiments of the present disclosure.

### DETAILED DESCRIPTION

Various embodiments of the present disclosure provide an image sensing device capable of detecting a distance to a target object according to a time-of-flight (TOF) method that may be used in configurations to substantially address one or more technical or engineering issues and to mitigate limitations or disadvantages encountered in some image sensing devices in the art. Some embodiments of the present disclosure relate to an image sensing device that includes a readout circuit shared by a plurality of quenching circuits configured to quench SPAD element(s), and forms a quenching circuit to be stacked with the SPAD element(s), resulting in reduction in a chip area. In recognition of the issues above, the image sensing device based on some embodiments of the present disclosure can be configured to have a short dead time within a small area.

Reference will now be made in detail to some embodiments of the present disclosure which are illustrated in the accompanying drawings. Wherever possible, the same reference numbers will be used throughout the drawings to refer to the same or like parts. While the embodiments of the present disclosure is susceptible to various modifications and alternative forms, specific embodiments thereof are shown by way of example in the drawings. However, the disclosure should not be construed as being limited to the embodiments set forth herein.

Hereinafter, various embodiments will be described with reference to the accompanying drawings. However, it should be understood that the disclosed technology is not limited to specific embodiments, but includes various modifications, equivalents and/or alternatives of the embodiments. The embodiments of the present disclosure may provide a variety of effects capable of being directly or indirectly recognized.

Various embodiments of the present disclosure relate to an image sensing device that includes a readout circuit shared by a plurality of quenching circuits configured to quench SPAD element(s), and forms a quenching circuit to be stacked with the SPAD element(s), resulting in reduction in a chip area.

It is to be understood that both the foregoing general description and the following detailed description of the disclosed technology are illustrative and descriptive and are intended to provide further description of the embodiments as claimed.

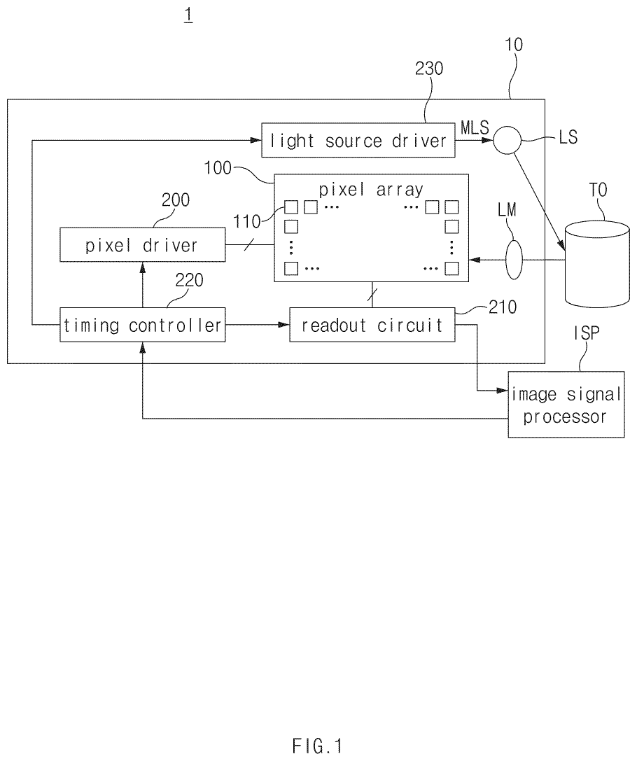

FIG. 1 is a schematic diagram illustrating an imaging device 1 based on some embodiments of the present disclosure.

Referring to FIG. 1, the imaging device 1 may refer to a device, for example, a digital still camera for photographing still images or a digital video camera for photographing moving images. For example, the imaging device 1 may be implemented as a Digital Single Lens Reflex (DSLR) camera, a mirrorless camera, or a smartphone, and others. The imaging device 1 may include a device having both a lens and an image pickup element such that the device can capture (or photograph) a target object and can thus create an image of the target object.

The imaging device 1 may include an image sensing device 10 and an image signal processor (ISP).

The image sensing device 10 can measure a distance to a target object using the Time of Flight (TOF) principle. The image sensing device 10 may include a light source (LS), a lens module (LM), a pixel array 100, a pixel driver 200, a readout circuit 210, a timing controller 220, and a light source driver 230.

The light source (LS) may emit light to a target object (TO) upon receiving a clock signal (MLS) from the light source driver 230. The light source (LS) may be a laser diode (LD) or a light emitting diode (LED) for emitting light (e.g., infrared (IR) light or visible light) having a specific wavelength band, or may be one of a Near Infrared Laser (NIR), a point light source, a monochromatic light source combined with a white lamp or a monochromator, and a combination of other laser sources. For example, the light source (LS) may emit infrared (IR) light having a wavelength of 800 nm to 1000 nm. Light emitted from the light source (LS) may be modulated light modulated at a predetermined frequency. Although FIG. 1 shows only one light source (LS) for convenience of description, the scope or spirit of the disclosed technology is not limited thereto, and a plurality of light sources (LSs) may also be arranged in the vicinity of the lens module (LM).

The lens module (LM) may collect light reflected from the target object (TO), and may allow the collected light to be focused onto pixels of the pixel array 100. For example, the lens module (LM) may include a focusing lens having a surface formed of glass or plastic or another cylindrical optical element having a surface formed of glass or plastic. The lens module (LM) may include a single lens group of one or more lenses.

The pixel array 100 may include a plurality of pixels 110 consecutively arranged in a two-dimensional (2D) matrix structure in which pixels 110 are consecutively arranged in a column direction and a row direction perpendicular to the column direction. Each pixel 110 may convert incident light received through the lens module (LM) into an electrical signal corresponding to the amount of incident light, and may thus output a pixel signal using the electrical signal. In this case, the pixel signal may not indicate the color of the target object (TO), and may be a signal indicating the distance to the target object (TO).

The pixel array 100 in which the plurality of pixels 110 are arranged may detect the distance to the target object (TO) using the direct TOF method. The direct TOF method may directly measure a round trip time from a first time where pulse light is emitted to the target object (TO) to a second time where pulse light reflected from the target object (TO) is incident, and may thus calculate the distance to the target object (TO) by calculating the round trip time and the speed of light.

Each of the plurality of pixels 110 may include a light receiving element (i.e., a single-photon avalanche diode SPAD) according to an embodiment.

The principle of operating the pixel 110 including the SPAD is as follows. When an electric field is increased by applying a reverse bias voltage to the SPAD, impact ionization may occur in which a pair of an electron and a hole (hereinafter referred to as an electron-hole pair) is generated while an electron generated by a photon due to the strong electric field moves. Specifically, in the SPAD operating in a Geiger mode in which a reverse bias voltage that is higher than a breakdown voltage is applied, when electrons and holes generated by impact ionization caused by collision with carriers (i.e., electrons or holes) generated by incident light collide with each other, countless carriers can be generated. As a result, even if a single photon is incident upon the SPAD, the single photon may trigger an avalanche breakdown, so that a measurable current pulse can be generated.

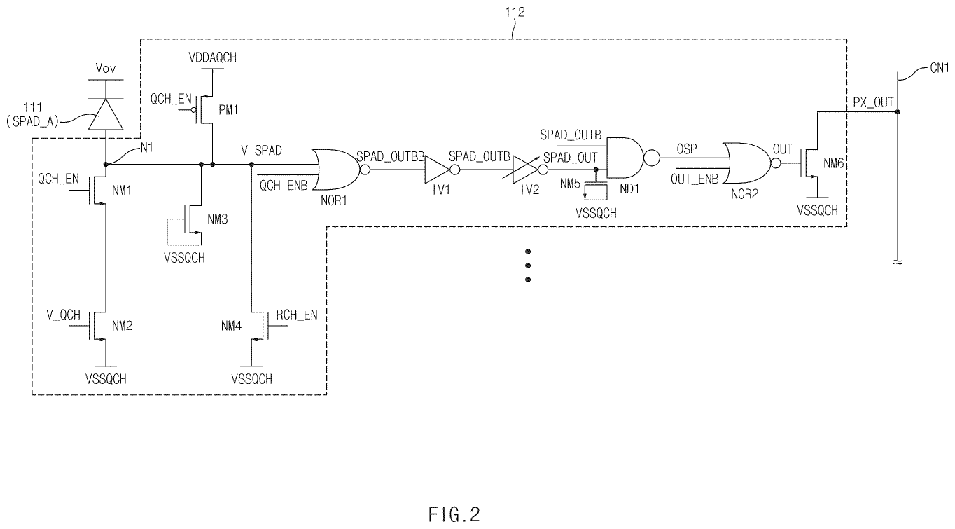

Each of the plurality of pixels 110 may include a quenching circuit (i.e., a quenching circuit 112 to be described later) corresponding to the SPAD element. The pixel 110 based on some embodiments of the present disclosure may include an array of the quenching circuits respectively corresponding to the SPAD elements. In addition, the array of the quenching circuits may be connected to one readout circuit 210 by connecting to one common node (i.e., common node CN to be described later). Here, the quenching circuit may process the output of the corresponding SPAD element to output a pixel signal. A more detailed structure and operation of the pixel 110 will be described later with reference to FIGS. 2 to 4.

On the other hand, although an embodiment of the present disclosure has disclosed a single-photon avalanche diode (SPAD) element acting as a light receiving element (i.e., a light detection element) of a pixel for convenience of description, the scope or spirit of the disclosed technology is not limited to the SPAD element. That is, not only the SPAD element, but also various elements that operate in the Geiger mode, such as an avalanche photodiode (APD) or a silicon photomultiplier (SiPM), can be used as the light receiving element of the pixel.

The pixel driver 200 may drive the pixel array 100 under the control of the timing controller 220. For example, the pixel driver 200 may generate a quenching control signal to control a quenching operation that reduces a reverse bias voltage applied to the SPAD element of the pixel 110 to a breakdown voltage or less. In addition, the pixel driver 200 may generate a recharge signal for controlling a recharging operation that implants charges into a sensing node connected to the SPAD element of the pixel 110.

The readout circuit 210 may be disposed at one side of the pixel array 100, may calculate a time delay between a pulse signal output from each pixel 110 and a reference pulse, and may generate digital data corresponding to the time delay. Here, the reference pulse may be a pulse of the clock signal (MLS). The readout circuit 210 may include a digital logic circuit configured to generate digital data by calculating a time delay between a pulse signal of each pixel 110 and a reference pulse, and an output buffer configured to store the generated digital data. The digital logic circuit and the output buffer may hereinafter be collectively referred to as a Time-to-Digital Circuit (TDC). The readout circuit 210 may transmit the stored digital data to the image signal processor (ISP) under the control of the timing controller 220.

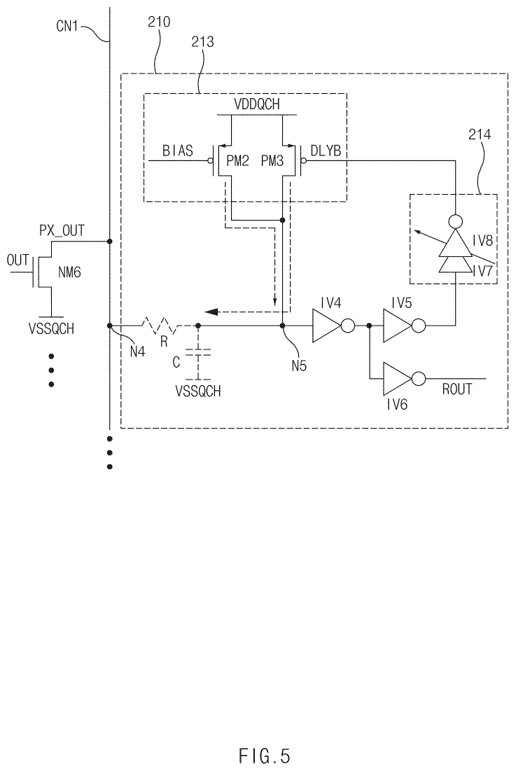

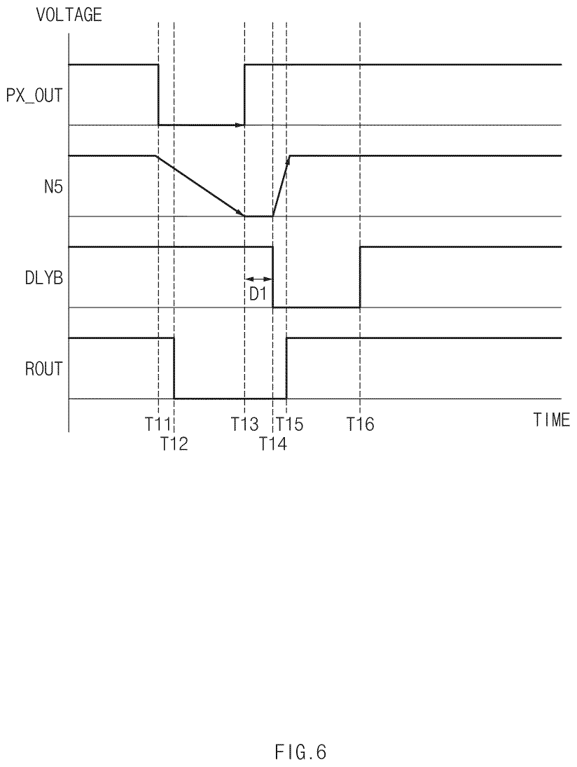

In addition, according to an embodiment of the present disclosure, one readout circuit 210 may be shared by a plurality of pixels 110 (i.e., a plurality of quenching circuits 112). The readout circuit 210 may drive pixel signals received from the plurality of pixels 110, may transmit the pixel signals to one common node (to be described later), and may control a delay time of each signal received through the common node to generate a readout signal (i.e., a pulse signal). The readout signal generated by the readout circuit 210 may be output to the TDC circuit described above. A more detailed structure and operation of the readout circuit 210 will be described later with reference to FIGS. 5 and 6.

The timing controller 220 may control overall operation of the image sensing device 10. That is, the timing controller 220 may generate a clock signal and a timing signal to control operations of the pixel driver 200 and the light source driver 230. In addition, the timing controller 220 may control activation or deactivation of the readout circuit 210, and may control digital data stored in the readout circuit 210 to be simultaneously or sequentially transmitted to the image signal processor ISP.

The light source driver 230 may generate a clock signal (MLS) that can drive the light source (LS) under the control of the timing controller 220.

The image signal processor (ISP) may process digital data received from the image sensing device 10 and may generate a depth image indicating the distance to the target object (TO). In more detail, the image signal processor (ISP) may calculate the distance to the target object (TO) for each pixel 110 based on a time delay denoted by digital data received from the readout circuit 210.

The image signal processor (ISP) may control operations of the image sensing device 10. Specifically, the image signal processor (ISP) may analyze digital data received from the image sensing device 10, may decide a mode of the image sensing device 10 based on the analyzed result, and may control the image sensing device 10 to operate in the determined mode.

The image signal processor (ISP) may perform image signal processing of the depth image such that the image signal processor (ISP) can perform noise cancellation and image quality improvement of the depth image. The depth image generated from the image signal processor (ISP) may be stored in an internal memory of an imaging device, or a device including the imaging device or in an external memory either in response to a user request or in an automatic manner, such that the stored depth image can be displayed through a display. Alternatively, the depth image generated from the image signal processor (ISP) may be used to control operations of the imaging device or the device including the imaging device.

FIG. 2 is a detailed circuit diagram illustrating the pixel array of the image sensing device shown in FIG. 1 based on some embodiments of the present disclosure.

Referring to FIG. 2, the pixel array 100 may include a plurality of pixels 110. Each of the pixels 110 may include an SPAD element 111 (e.g., SPAD_A) and a quenching circuit 112.

Here, the SPAD element 111 may detect a single photon reflected by the target object (TO) and may generate a current pulse corresponding to the detected single photon. The SPAD element 111 may operate as a photodiode including a photosensitive P-N junction. Since avalanche breakdown is triggered by a single photon incident in a Geiger mode in which a reverse bias voltage caused by a cathode-anode voltage higher than a breakdown voltage occurs, the SPAD element 111 may generate a current pulse. In this way, the process in which avalanche breakdown is triggered by a single photon and a current pulse is generated will hereinafter be defined as an avalanche process.

One terminal of the SPAD element 111 may receive a first bias voltage (Vₒᵥ) for applying a reverse bias voltage (hereinafter referred to as an “operation voltage”) higher than the breakdown voltage to the SPAD element 111. For example, the first bias voltage (Vₒᵥ) may be a positive voltage having an absolute value lower than the absolute value of the breakdown voltage. The other terminal of the SPAD element 111 may be connected to a sensing node N1. The SPAD element 111 may output the current pulse generated by detecting a single photon to the sensing node N1. The current pulse generated by the SPAD element 111 may be output to a NOR gate (NOR1) at a sensing voltage (V_SPAD).

The quenching circuit 112 may process the output of the SPAD element 111 and may output a pixel signal (PX_OUT). For example, the quenching circuit 112 may control the reverse bias voltage applied to the SPAD element 111, may convert the current pulse applied to the sensing node N1 into a digital-type pulse signal, and may thus output a pixel signal (PX_OUT).

The quenching circuit 112 may include a plurality of NMOS transistors (NM1˜NM6), a PMOS transistor (PM1), a plurality of NOR gates (NOR1, NOR2), a NAND gate (ND1), and a plurality of inverters (IV1, IV2).

Here, the NMOS transistor NM1 (also referred to as an “enable transistor”) may be connected between the sensing node N1 and the NMOS transistor (NM2), and may receive a quenching enable signal (QCH_EN) through a gate terminal thereof. The NMOS transistor NM2 (also referred to as a “bias transistor”) may be connected between the NMOS transistor (NM1) and a ground voltage (VSSQCH) input terminal, and may receive a quenching bias voltage (V_QCH) through a gate terminal thereof.

In addition, the NMOS transistor NM3 (also referred to as a “clamp transistor”) may be connected between the sensing node N1 and the ground voltage (VSSQCH) input terminal, and may receive the ground voltage (VSSQCH) through a gate terminal thereof. The NMOS transistor (NM3) may serve as a diode because a gate terminal and a source terminal thereof are commonly connected to the ground voltage (VSSQCH) input terminal. When an overvoltage exceeding a clamp voltage (e.g., a preset voltage) occurs in the SPAD element 111, the NMOS transistor NM3 may clamp the overvoltage to a constant voltage (e.g., a forward voltage).

The NMOS transistor (NM4) (also referred to as a “recharging transistor”) may be connected between the sensing node (N1) and the ground voltage (VSSQCH) input terminal, and may receive a recharge signal (RCH_EN) through a gate terminal thereof. When the recharge signal (RCH_EN) is activated, the NMOS transistor (NM4) is turned on and the sensing node (N1) can be recharged to the ground voltage (VSSQCH) level. After the avalanche process is quenched, the NMOS transistor NM4 may implant charges into the sensing node such that the SPAD element 111 can re-enter the Geiger mode to induce an avalanche breakdown. Here, the recharge signal (RCH_EN) may be a signal which is input by feedback of a quenching signal SPAD_OUTB (or a quenching signal SPAD_OUTBB). The recharge signal (RCH_EN) may be a signal having the same logic level as the quenching signal SPAD_OUTB (or the quenching signal SPAD_OUTBB). Since the NMOS transistor NM4 operates by the recharge signal (RCH_EN) indicating a feedback signal of the quenching signal SPAD_OUTB (or the quenching signal SPAD_OUTBB), the recharge operation can be quickly performed after completion of the quenching operation.

The PMOS transistor PM1 (also referred to as a “precharge transistor”) may be connected between a first power-supply voltage (VDDAQCH) and the sensing node (N1), and may receive a quenching enable signal (QCH_EN) through a gate terminal thereof.

The NMOS transistor (NM1) and PMOS transistor (PM1) may operate complementarily to each other. Accordingly, when the quenching enable signal (QCH_EN) is activated, the NMOS transistor (NM1) may be turned on and the PMOS transistor (PM1) may be turned off. On the other hand, when the quenching enable signal (QCH_EN) is deactivated, the NMOS transistor (NM1) may be turned off and the PMOS transistor (PM1) may be turned on. As a result, the sensing voltage (V_SPAD) can be precharged to a voltage level of the first power-supply voltage (VDDAQCH).

The NOR gate (NOR1) (also referred to as a “first logic operation circuit”) may perform a NOR operation on the sensing voltage (V_SPAD) received from the sensing node (N1) and the quenching enable bar signal (QCH_ENB), and may thus output a quenching signal (SPAD_OUTBB). In this case, the quenching enable bar signal (QCH_ENB) may be an inverted signal of the quenching enable signal (QCH_EN).

The inverter IV1 (also referred to as an “inversion circuit”) may invert the quenching signal (SPAD_OUTBB) to output the quenching signal (SPAD_OUTB). Here, the quenching signal (SPAD_OUTB) may be an inversion signal of the quenching signal (SPAD_OUTBB). Additionally, the inverter IV2 may invert the quenching signal (SPAD_OUTB) to output the quenching signal (SPAD_OUT). The quenching signal (SPAD_OUT) may be an inversion signal of the quenching signal (SPAD_OUTB). In the embodiment of FIG. 2, the circuit for generating the quenching signal (SPAD_OUT) is shown only as the inverter (IV2), but it is not limited thereto. Alternatively, the MOS transistor may be connected to the inverter (IV2) to adjust a dynamic current of the inverter (IV2) and a time delay of the quenching signal (SPAD_OUTB), such that a circuit capable of generating the quenching signal (SPAD_OUT) can be implemented. Accordingly, the configuration of the inverter (IV2) may also be referred to as an “inverting circuit” or a “delay circuit”.

In addition, the source and drain terminals of the NMOS transistor NM5 (also referred to as a “pull-down transistor”) may be commonly connected between the ground voltage (VSSQCH) input terminals. In addition, the NMOS transistor (NM5) may receive the quenching signal (SPAD_OUT) through a gate terminal thereof. The NMOS transistor NM5 may operate as a capacitor and therefore the NMOS transistor (NM5) can control a slope of the quenching signal (SPAD_OUT).

The NAND gate (ND1) (also referred to as a “second logic operation circuit”) may output a one-shot pulse signal (OSP) by performing a NAND operation on the quenching signal (SPAD_OUTB) and the other quenching signal (SPAD_OUT). The NAND gate (ND1) may generate a one-shot pulse signal (OSP) having one pulse by performing a NAND operation on the quenching signal (SPAD_OUT), the slope of which is adjusted by the NMOS transistor (NM5), and the quenching signal (SPAD_OUTB). In this case, a structure including the NMOS transistor (NM5) and the NAND gate (ND1) will hereinafter be collectively referred to as a “pulse generation circuit”.

The NOR gate (NOR2) (also referred to as a “third logic operation circuit”) may generate an output signal (OUT) by performing a NOR operation on the one-shot pulse signal (OSP) and the output enable signal (OUT_ENB).

The NMOS transistor NM6 (also referred to as a “drive element”) may be connected between the output terminal of the pixel signal (PX_OUT) and the ground voltage (VSSQCH) input terminal, and may receive the output signal (OUT) through a gate terminal thereof. The pixel signal (PX_OUT) having a pulse shape may be output through the NMOS transistor (NM6). In this case, a structure including the NOR gate (NOR2) and the NMOS transistor (NM6) will hereinafter be collectively referred to as an “output circuit”.

In the quenching circuit 112 having the above-described constituent elements, the PMOS transistor (PM1) and the NOR gate (NOR1) may receive the first power-supply voltage (VDDAQCH) as a source power. In the quenching circuit 112, the plurality of inverters (IV1, IV2), the NAND gate (ND1), and the NOR gate (NOR2) may receive a second power-supply voltage (VDDQCH) as a source power. In this case, the second power-supply voltage (VDDQCH) may be lower than the first power-supply voltage (VDDAQCH). For example, the first power-supply voltage (VDDAQCH) may be a voltage generated by level-shifting the second power-supply voltage (VDDQCH).

In addition, the quenching enable signal (QCH_EN), the quenching bias voltage (V_QCH), and the output enable signal (OUT_ENB) described above may be supplied from the pixel driver 200 shown in FIG. 1.

In addition, the pixel array 100 shown in FIG. 2 may include a plurality of SPAD elements 111 and a plurality of quenching circuits 112. The plurality of SPAD elements 111 and the plurality of quenching circuits 112 may be connected to one common node (CN1). For example, when the number of SPAD elements 111 is 144 and the number of quenching circuits 112 is 144, 144 NMOS transistors (NM6), each of which is located at an output end of each quenching circuit 112, can be connected to one common node (CN1). The common node (CN1) may be shared by 144 NMOS transistors (NM6). The common node (CN1) may be an input node of the readout circuit 210, which will be described later in detail with reference to FIG. 5.

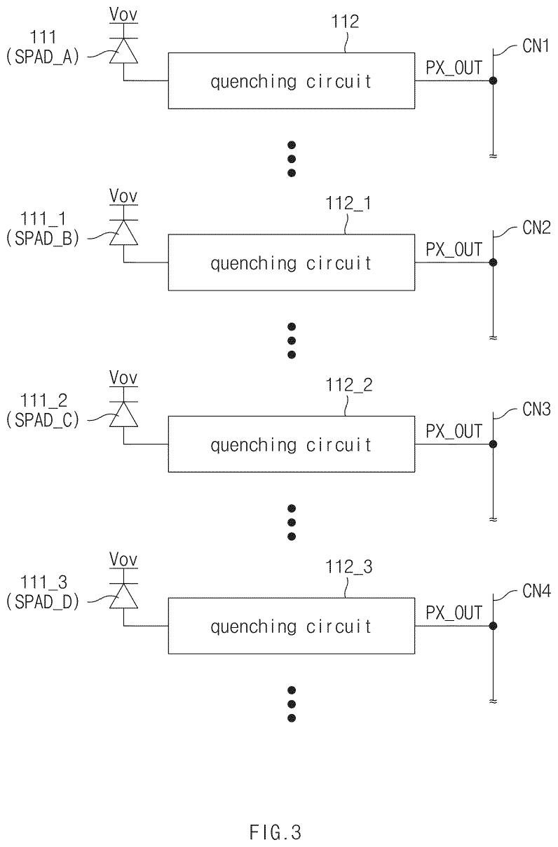

FIG. 3 is a diagram illustrating a structure of the pixel array 100 shown in FIG. 2 based on some embodiments of the present disclosure.

Referring to FIG. 3, the pixel array 100 may include a plurality of SPAD elements (111, 111_1, 111_2, 111_3) and a plurality of quenching circuits (112, 112_1, 112_2, 112_3). Since the detailed configuration of the quenching circuits (112_1, 112_2, 112_3) is the same as the quenching circuit 112 shown in FIG. 2, redundant circuit diagrams and detailed descriptions of the quenching circuits (112_1, 112_2, 112_3) of FIG. 3 will herein be omitted for brevity.

In this case, the SPAD element 111 may hereinafter be referred to as a SPAD_A element, the SPAD element 111_1 may hereinafter be referred to as a SPAD_B element, the SPAD element 111_2 may hereinafter be referred to as a SPAD_C element, and the SPAD element 111_3 may hereinafter be referred to as a SPAD_D element.

Although FIG. 2 illustrates only the plurality of SPAD elements 111 and the plurality of quenching circuits 112 connected to one common node (CN1) for convenience of description, the scope or spirit of the disclosed technology is not limited thereto. As can be seen from FIG. 3, the plurality of SPAD elements (111_1˜111_3) and the plurality of quenching circuits (112_1˜112_3) can be implemented to be respectively connected to the plurality of common nodes (CN2˜CN4). In more detail, the SPAD element 111_1 and the quenching circuit 112_1 may be connected to the common node (CN2), the SPAD element 111_2 and the quenching circuit 112_2 may be connected to the common node (CN3), and the SPAD element 111_3 and the quenching circuit 112_3 may be connected to the common node (CN4).

For example, when there are 144 SPAD elements 111_1 and 144 quenching circuits 112_1, 144 NMOS transistors (NM6), which are output circuits of the quenching circuits 112_1, can be connected to one common node (CN2). The common node (CN2) may be shared by the plurality of SPAD elements 111_1 and the plurality of quenching circuits 112_1. The common node (CN2) may be connected to one readout circuit 210.

When there are 144 SPAD elements 111_2 and 144 quenching circuits 112_2, 144 NMOS transistors (NM6), which are the output circuits of the quenching circuit 112_2, can be connected to one common node (CN3). The common node (CN3) may be shared by the plurality of SPAD elements 111_2 and the plurality of quenching circuits 112_2. The common node (CN3) may be connected to one readout circuit 210.

When there are 144 SPAD elements 111_3 and 144 quenching circuits 112_3, 144 NMOS transistors (NM6), which are the output circuits of the quenching circuit 112_3, can be connected to one common node (CN4). The common node (CN4) may be shared by the plurality of SPAD elements 111_3 and the plurality of quenching circuits 112_3. The common node (CN4) may be connected to one readout circuit 210.

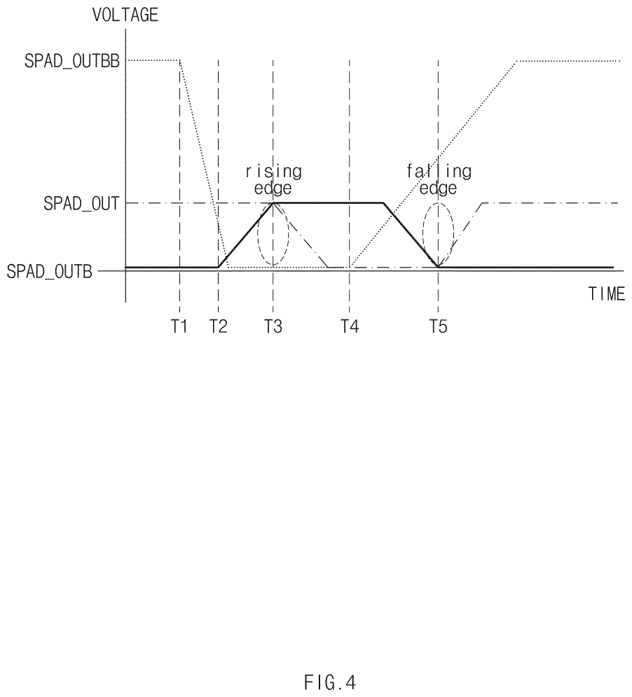

FIG. 4 is a timing diagram illustrating operations of the quenching circuit shown in FIG. 2 based on some embodiments of the present disclosure.

Referring to FIG. 4, when the NMOS transistor (NM2) is turned on by the quenching bias voltage (V_QCH) and the quenching enable signal (QCH_EN) is activated, the NMOS transistor (NM1) may be turned on. As a result, the sensing voltage (V_SPAD) of a logic low level may be applied to the NOR gate (NOR1) through the sensing node N1. When the sensing voltage (V_SPAD) of a logic low level and the quenching enable bar signal (QCH_ENB) of a logic low level are input to the NOR gate (NOR1), the quenching signal (SPAD_OUTBB) may become at a logic high level and the quenching signal (SPAD_OUTB) may become at a logic low level.

A time point T1 may be a section in which an avalanche breakdown is triggered by a single photon and a current pulse is generated. When the quenching enable bar signal (QCH_ENB) is at a logic low level and the sensing voltage (V_SPAD) transitions to a logic high level due to the operation of the SPAD element 111, the quenching signal (SPAD_OUTBB), which is the output of the NOR gate (NOR1), may transition to a logic low level.

Thereafter, the quenching signal (SPAD_OUTB), which is the output of the inverter (IV1), may transition from a logic low level to a logic high level at a time point T2. As described above, the inverter (IV1) is driven by the second power-supply voltage (VDDQCH) and the NOR gate (NOR1) is driven by the first power-supply voltage (VDDAQCH), the second power-supply voltage (VDDQCH) being lower than the first power-supply voltage (VDDAQCH), and therefore the quenching signal (SPAD_OUTB) may have a lower voltage level than the quenching signal (SPAD_OUTBB).

Subsequently, the quenching signal (SPAD_OUT), which is the output signal of the inverter (IV2), may transition to a logic low level in synchronization with a rising edge of the quenching signal (SPAD_OUTB) (at a time point T3). Then, when the sensing voltage (V_SPAD) transitions to a logic low level, the quenching signal (SPAD_OUTBB) may transition again to a logic high level at a time point T4. Thereafter, the quenching signal (SPAD_OUT) may transition to a logic high level in synchronization with a falling edge of the quenching signal (SPAD_OUTB) (at a time point T5).

The NAND gate (ND1) may perform a NAND operation on the quenching signal (SPAD_OUT), the slope of which is adjusted by the NMOS transistor (NM5), and the quenching signal (SPAD_OUTB), and may generate a one-shot pulse signal (OSP) with a logic level of 0 or 1. The NAND gate (ND1) may reduce or increase a pulse width of the one-shot pulse signal (OSP) by adjusting a time delay between the quenching signal (SPAD_OUTB) and the quenching signal (SPAD_OUT). As an example, there may occur the one-shot pulse signal (OSP) that transitions to a logic high level at the time point T3 that is the time point of the rising edge of the quenching signal (SPAD_OUTB), and then transitions to a logic low level at the time point T5 that is the time point of the falling edge of the quenching signal (SPAD_OUTB).

Thereafter, the output signal (OUT) may be controlled based on a logic level of the one-shot pulse signal (OSP) in a state in which the output enable signal (OUT_ENB) of a logic low level is applied to the NOR gate (NOR2). For example, when the one-shot pulse signal (OSP) of a logic high level is applied to the NOR gate (NOR2), the output signal (OUT) becomes at a logic low level and the NMOS transistor (NM6) may be turned off. On the other hand, when the one-shot pulse signal (OSP) of a logic low level is applied to the NOR gate (NOR2), the output signal (OUT) becomes at a logic high level and the NMOS transistor (NM6) can be turned on. As a result, the pixel signal (PX_OUT) having a logic low level can be output to the common node (CN1).

FIG. 5 is a detailed circuit diagram illustrating the readout circuit 210 of the image sensing device shown in FIG. 1 based on some embodiments of the present disclosure. In the embodiment of FIG. 5, the readout circuit 210 shared by the plurality of quenching circuits 112 shown in FIG. 2 will be described as an example.

Referring to FIG. 5, the readout circuit 210 may control the

pixel signal (PX_OUT) received from the common node (CN1), and may generate a readout signal (ROUT). The readout circuit 210 may include a drive circuit 213, a plurality of inverters (IV4, IV5, IV6) (also referred to as “inverting elements”), and a delay control circuit 214.

In this case, the drive circuit 213 may selectively supply the second power-supply voltage (VDDQCH) to the node N5 based on a bias signal (BIAS) and a delay signal (DLYB). The drive circuit 213 may include a plurality of PMOS transistors (PM2, PM3) (also referred to as “drive transistors”).

The PMOS transistor (PM2) may be connected between an input terminal of the second power-supply voltage (VDDQCH) and the node N5 and the PMOS transistor (PM2) may receive the bias signal (BIAS) through a gate terminal thereof. In this case, the bias signal (BIAS) may be a signal generated by the timing controller 220 described above. In addition, the PMOS transistor (PM3) may be connected between the input terminal of the second power-supply voltage (VDDQCH) and the node N5 and the PMOS transistor (PM3) may receive the delay signal (DLYB) through a gate terminal thereof.

The inverter (IV4) may invert the output signal of the node N5. The inverter (IV5) may invert the output signal of the inverter (IV4). The inverter (IV6) may invert the output signal of the inverter (IV4), and may output a readout signal (ROUT).

The delay control circuit 214 may control a delay time of the output signal of the inverter (IV5), and may output the delay signal (DLYB).

The delay control circuit 214 may include a plurality of inverters (IV7, IV8) (so-called “delay elements”) configured to perform non-inverting delay of the output signal of the inverter (IV5). Although an embodiment has disclosed that the delay control circuit 214 is shown as including two inverters (IV7, IV8), the scope or spirit of the disclosed technology is not limited thereto, and it should be noted that the number of inverters can be sufficiently changed depending on the delay time.

As described above, one common node (CN1) may be shared by the plurality of NMOS transistors (NM6). Since the node (N4) connected to the common node (CN1) is connected to the plurality of NMOS transistors (NM6), parasitic resistance such as a resistor R and parasitic capacitance such as a capacitor C may exist. Thus, the drive circuit 213 may precharge the node (N5) with the second power-supply voltage (VDDQCH) based on the bias signal (BIAS) and the delay signal (DLYB). In addition, the readout circuit 210 may control the delay time of a voltage level of the node (N5) using the delay control circuit 214, and may thus compensate for a delay time caused by parasitic resistance and parasitic capacitance.

FIG. 6 is a timing diagram illustrating operations of the readout circuit shown in FIG. 5 based on some embodiments of the present disclosure.

Referring to FIG. 6, when the bias signal (BIAS) of the drive circuit 213 transitions to a logic low level while the pixel signal (PX_OUT) is at a logic high level, the PMOS transistor (PM2) may be turned on. Then, the node (N5) can be precharged to the level of the second power-supply voltage (VDDQCH). When the node (N5) is at a logic high level, the delay signal (DLYB) and the readout signal (ROUT) may also be maintained at a logic high level.

Thereafter, when the output signal (OUT) of the quenching circuit 112 transitions to a logic high level and the NMOS transistor NM6 is turned on, the pixel signal (PX_OUT) may transition to a logic low level. Then, the node (N5) connected to the common node (CN1) can be pulled down to the ground voltage (VSSQCH) level (at a time point T11).

When the voltage level of the node (N5) decreases, the readout signal (ROUT) may also transition to a logic low level (at a time point T12) after lapse of the delay time corresponding to the inverters (IV4, IV6).

Thereafter when the output signal (OUT) of the quenching circuit 112 goes back to a logic low level and the NMOS transistor (NM6) is turned off, the pixel signal (PX_OUT) may transition to a logic high level (at a time point T13). When the voltage level of the node (N5) becomes at a logic low level, the delay signal (DLYB) may transition to a logic low level (at a time point T14) after the delay time corresponding to the inverting elements (IV4, IV5) and the delay time (D1) corresponding to the delay control circuit 214 have elapsed. Then, the PMOS transistor (PM3) may be turned on and the second power-supply voltage (VDDQCH) can be supplied to the node (N5). Accordingly, the voltage level of the node (N5) gradually increases and the node (N5) can be precharged.

When a section during which the pixel signal (PX_OUT) is activated to a logic low level is short (that is, when the pulse width of the pixel signal (PX_OUT) is short), the section during which the node N5 is pulled down is shortened. In this case, the node (N5) may not be sufficiently pulled down and a current may not flow between the common node (CN1) (i.e., the node N5) and the PMOS transistor (PM3).

According to an embodiment of the present disclosure, the delay signal (DLYB) can be maintained at a logic high level during the delay time (D1) corresponding to the delay control circuit 214. As a result, the PMOS transistor (PM3) may remain turned off during the delay time (D1) and therefore a time section (e.g., a time section from T13 to T14) in which the node (N5) is pulled down can be sufficiently secured.

Subsequently, when the voltage level of the node (N5) gradually increases from a logic low level and then transitions to a logic high level, the readout signal (ROUT) may also transition to a logic high level (at a time point T15). After lapse of a predetermined time from a time point at which the readout signal (ROUT) transitions to the logic high level, the delay signal (DLYB) may transition to a logic high level and the PMOS transistor (PM3) can be turned off (at a time point T16).

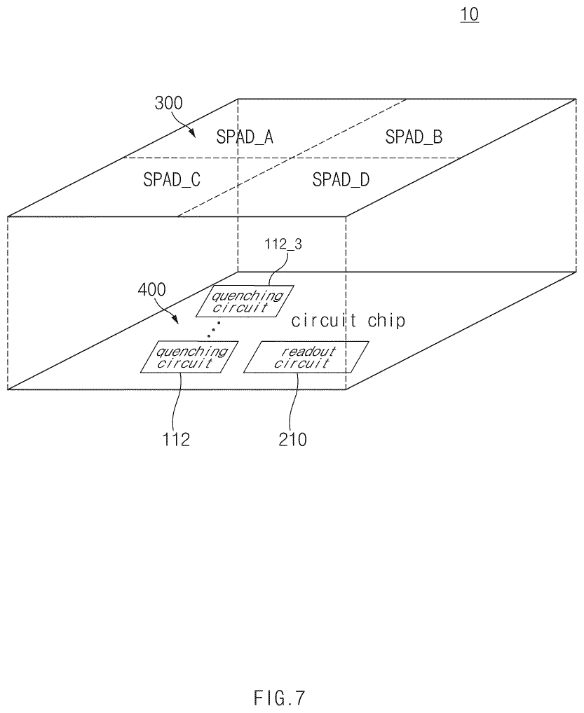

FIG. 7 is a diagram illustrating a stacked structure of the image sensing device 10 shown in FIG. 1 based on some embodiments of the present disclosure.

Referring to FIG. 7, the image sensing device 10 may have a stacked structure in which a sensor chip 300 and a circuit chip 400 are vertically bonded to each other.

The sensor chip 300 and the circuit chip 400 may be electrically connected to each other through a connector (not shown), such that signals can be communicated between the sensor chip 300 and the circuit chip 400.

In the sensor chip 300, the plurality of SPAD elements (SPAD_A˜SPAD_D) shown in FIGS. 2 and 3 may be arranged in a matrix shape. For example, the plurality of SPAD elements (SPAD_A˜SPAD_D) may be arranged in a (2×2) matrix including rows and columns.

The circuit chip 400 may include the plurality of quenching circuits (112, 112_1, 112_2, 112_3) shown in FIGS. 2 and 3 and the readout circuit 210 shown in FIG. 5. The plurality of quenching circuits (112, 112_1, 112_2, 112_3) included in the circuit chip 400 may be respectively connected to the plurality of SPAD elements (SPAD_A˜SPAD_D) included in the sensor chip 300. In addition, the readout circuit 210 may be shared by the plurality of quenching circuits (112, 112_1, 112_2, 112_3).

The circuit chip 400 may include the pixel driver 200, the

timing controller 220, and the light source driver 230 shown in FIG. 1. Depending on the embodiment, the circuit chip 400 may include a level shifter that generates the first power-supply voltage (VDDAQCH) by level-shifting the second power-supply voltage (VDDQCH), and other peripheral circuits.

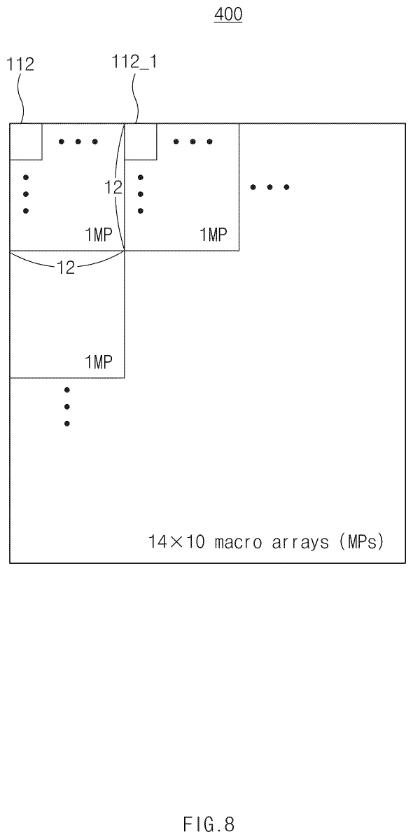

FIG. 8 is a diagram illustrating a logic array included in the circuit chip shown in FIG. 7 based on some embodiments of the present disclosure.

The logic array may include the quenching circuits (112, 112_1, 112_2, 112_3), the readout circuit 210, the pixel driver 200, the timing controller 220, the light source driver 230, the level shifter, and other peripheral circuits described above, but the scope or spirit of the disclosed technology is not limited thereto, and the arrangement relationship of the quenching circuit 112 will hereinafter be described in detail with reference to the embodiment of FIG. 8.

Referring to FIG. 8, the quenching circuit 112 may be disposed in the circuit chip 400.

For example, the circuit chip 400 may include a plurality of quenching circuits 112 consecutively arranged in a two-dimensional (2D) matrix structure. That is, the plurality of quenching circuits 112 may be consecutively arranged in the row and column directions.

In some embodiments, a (12×12) matrix of quenching circuits 112 arranged in rows and columns may be grouped into a single macro array (denoted by ‘1MP’). In the single macro array 1MP, the 144 (=12×12) quenching circuits 112 may share the readout circuit 210. In the circuit chip 400, the macro array (1MP) may be consecutively arranged in the row and column directions. As an example, a (14×10) matrix of the macro arrays (1MPs) may be arranged in rows and columns.

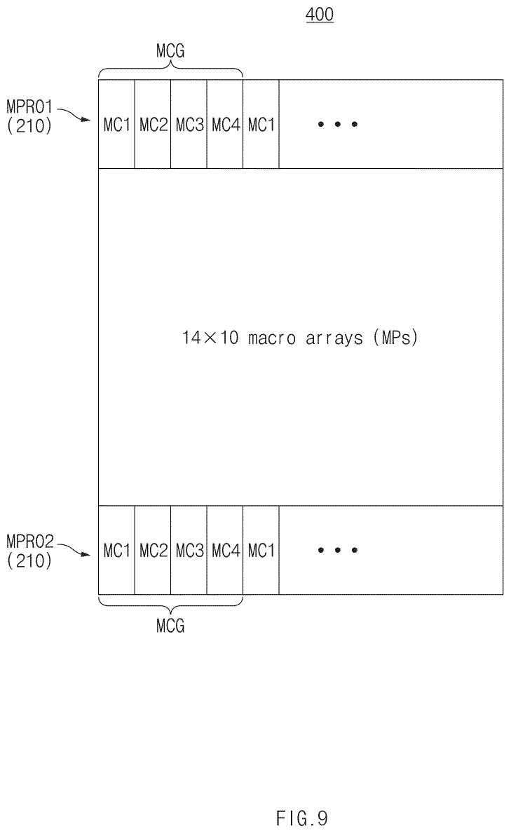

The above embodiment of the present disclosure discloses that the quenching circuits 112 construct a macro array unit in which the (12×12) quenching circuits 112 are arranged and the (14×10) macro arrays are arranged for convenience of description and better understanding of the disclosed technology, but it is not limited thereto, and it should be noted that the number of quenching circuits and the number of macro arrays can also be sufficiently changed to other numbers without departing from the scope of the disclosed technology. FIG. 9 is a schematic diagram illustrating an arrangement

structure of the macro array and the readout circuit within the circuit chip shown in FIGS. 7 and 8.

Referring to FIG. 9, the number of macro arrays (MPs) may be set to 140 (=14×10) and the (14×10) macro arrays can be arranged in the circuit chip 400 as shown in FIG. 8. The readout circuits 210 may be arranged at one side (e.g., an upper side) and the other side (e.g., a lower side) of the macro array (MP), respectively.

The readout circuit 210 arranged at one side (upper side) of the macro array (MP) will hereinafter be defined as a first readout circuit (MPRO1) for convenience of description. As an example, the first readout circuit (MPRO1) may include 280 macro cells (MCs). One readout circuit 210 is defined as a ‘macro cell’. Here, four macro cells (MC1˜MC4) may be grouped into a macro cell group (MCG). The macro cell group (MCG) may be repeatedly arranged in the row direction at one side of the circuit chip 400.

In addition, the readout circuit 210 disposed at the other side (lower side) of the macro array (MP) will hereinafter be defined as a second readout circuit (MPRO2). As an example, the second readout circuit (MPRO2) may include 280 macro cells (MCs). Here, four macro cells (MC1˜MC4) may be grouped into a macro cell group (MCG). The macro cell group (MCG) may be repeatedly arranged in the row direction at the other side of the circuit chip 400.

As an example, four macro cells (MC1˜MC4) may be allocated to each macro array (1MP). Thus, when a total number of macro arrays (MPs) is 140, a total of 560 macro cells can be arranged in the circuit chip 400 and the 560 macro cells (MCs) are divided into halves in a manner that 280 macro cells are disposed at the upper side of the circuit chip and the remaining 280 macro cells are disposed at the lower side of the circuit chip 400.

Although an embodiment of the present disclosure discloses that a total number of macro cells is set to 560 for convenience of description and better understanding of the disclosed technology, other implementations are also possible, and it should be noted that the number of macro cells (MCs) can be sufficiently changed without departing from the scope or spirit of the disclosed technology.

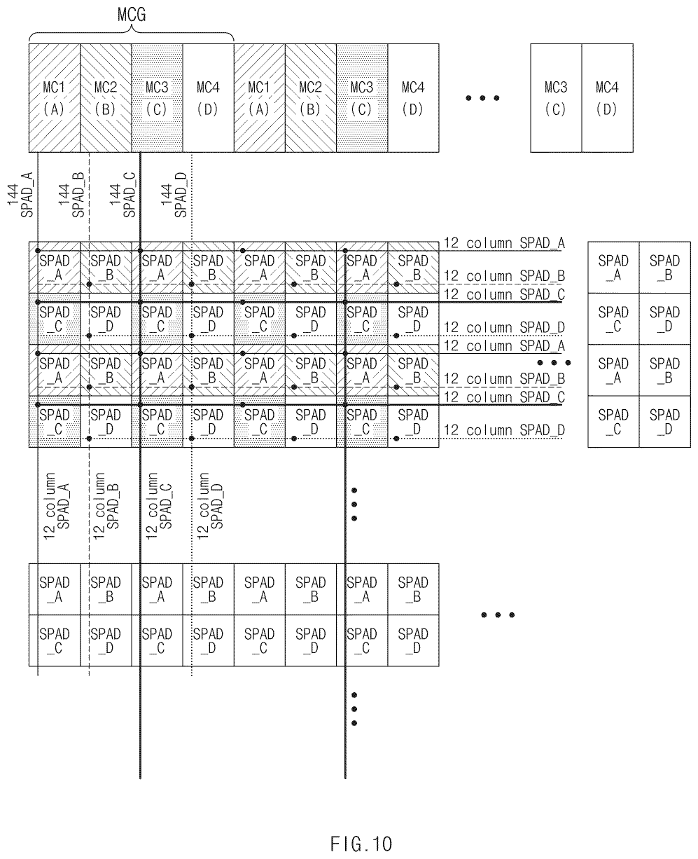

FIG. 10 is a diagram illustrating a routing structure of the SPAD device of FIG. 7 and the readout circuit of FIG. 9 based on some embodiments of the present disclosure.

Referring to FIG. 10, the SPAD device may include a plurality of SPAD elements (SPAD_A˜SPAD_D) as shown in FIG. 7. In addition, four macro cells (MC1˜MC4) may construct a macro cell group (MCG), and may be repeatedly arranged in the row direction.

As can be seen from FIG. 10, the letters (A, B, C, D) respectively marked on the macro cells (MC1, MC2, MC3, MC4) may correspond to the letters (A, B, C, D) respectively marked on the SPAD elements (SPAD_A, SPAD_B, SPAD_C, SPAD_D) and the macro cell (MC) and the SPAD element (SPAD) having the same letters can be routed to each other. For example, one macro cell (MC) may process output signals of a total of 144 SPAD elements (SPADs). That is, when a total of 144 quenching circuits 112, each of which is shown in FIG. 2, are used, the drain terminals (i.e., the pixel-signal (PX_OUT) output terminals) of the 144 NMOS transistors (NM6) may be commonly connected to each other through the common node (CN1).

For example, the outputs of the quenching circuits 122 corresponding to 144 SPAD elements (SPAD_A) may be connected to each other through one common node (CN1), and the sensed pixel signals (PX_OUT) may be read out through one macro cell ‘MC1(A)’. The outputs of the quenching circuits 122_1 corresponding to 144 SPAD elements (SPAD_B) may be connected to each other through one common node (CN2), and the sensed pixel signals (PX_OUT) may be read out through one macro cell ‘MC2(B)’. The outputs of the quenching circuits 122_2 corresponding to 144 SPAD elements (SPAD_C) may be connected to each other through one common node (CN3), and the sensed pixel signals (PX_OUT) may be read out through one macro cell ‘MC3(C)’.

The outputs of the quenching circuits 122_3 corresponding to 144 SPAD elements (SPAD_D) may be connected to each other through one common node (CN4), and the sensed pixel signals (PX_OUT) can be read out through one macro cell ‘MC4(D)’.

As is apparent from the above description, the image sensing device based on some embodiments of the present disclosure can be configured to have a short dead time within a small area.

The embodiments of the present disclosure may provide a variety of effects capable of being directly or indirectly recognized.

Although a number of illustrative embodiments have been described, it should be understood that modifications and enhancements to the disclosed embodiments and other embodiments can be devised based on what is described and/or illustrated in the present disclosure.

What is claimed is:

1. An image sensing device comprising:
a plurality of light receiving elements each configured to generate a sensing voltage corresponding to a current pulse based on a photon reflected from a target object;
a plurality of quenching circuits corresponding to the respective light receiving elements and each configured to output a pixel signal by controlling the sensing voltage from a corresponding light receiving element of the light receiving elements; and
a readout circuit shared by the plurality of quenching circuits and configured to generate a readout signal by controlling a delay time of the pixel signal.

2. The image sensing device according to claim 1, wherein each of the light receiving elements is a single-photon avalanche diode (SPAD) element configured to generate the current pulse by detecting the photon.

3. The image sensing device according to claim 1, wherein the quenching circuit includes:
an enable transistor connected between a ground voltage input terminal and a sensing node, to which the current pulse is applied, and configured to receive a quenching enable signal through a gate terminal thereof;
a first logic operation circuit configured to output a first quenching signal by performing a logical operation on a signal of the sensing node and an inverted signal of the quenching enable signal;
a first inverting circuit configured to output a second quenching signal by inverting the first quenching signal;
a delay circuit configured to output a third quenching signal by delaying the second quenching signal;
a pulse generation circuit configured to generate a one-shot pulse signal based on the second quenching signal and the third quenching signal; and
an output circuit configured to generate the pixel signal based on the one-shot pulse signal and an output enable signal.

4. The image sensing device according to claim 3, wherein:
the first logic operation circuit is driven by a first power-supply voltage, and
the first inverting circuit and the delay circuit are driven by a second power-supply voltage lower than the first power-supply voltage.

5. The image sensing device according to claim 3, wherein the third quenching signal transitions to a logic low level in synchronization with a rising edge of the second quenching signal and transitions to a logic high level in synchronization with a falling edge of the second quenching signal.

6. The image sensing device according to claim 3, wherein the pulse generation circuit includes:
a pull-down transistor configured to receive the third quenching signal through a gate terminal thereof, source and drain terminals thereof being connected to the ground voltage input terminal; and
a second logic operation circuit configured to output the one-shot pulse signal by performing a logical operation on the second quenching signal and the third quenching signal.

7. The image sensing device according to claim 6, wherein:
the delay circuit is further configured to adjust a delay time of the second quenching signal,
the pull-down transistor is further configured to adjust a slope of the third quenching signal, and
the pulse generation circuit is further configured to adjust a pulse width of the one-shot pulse signal according to the adjusted delay time and the adjusted slope.

8. The image sensing device according to claim 3, wherein the output circuit includes:
a third logic operation circuit configured to generate an output signal by performing a logical operation on the one-shot pulse signal and the output enable signal; and
a drive element connected between an output terminal of the pixel signal and the ground voltage input terminal and configured to receive, through a gate terminal thereof, the output signal from the third logic operation circuit.

9. The image sensing device according to claim 3, wherein the quenching circuit further includes:
a bias transistor connected between the enable transistor and the ground voltage input terminal and configured to receive a quenching bias voltage through a gate terminal thereof;
a clamp transistor connected between the sensing node and the ground voltage input terminal and configured to receive a ground voltage through a gate terminal thereof;
a recharge transistor connected between the sensing node and the ground voltage input terminal and configured to receive a recharging signal through a gate terminal thereof; and
a precharge transistor connected between a first power-supply voltage and the sensing node and configured to receive the quenching enable signal through a gate terminal thereof.

10. The image sensing device according to claim 1, wherein the plurality of quenching circuits output the respective pixel signals to a single common node connected to an input terminal of the readout circuit.

11. The image sensing device according to claim 1, wherein the readout circuit includes:
a drive circuit configured to precharge a first node with a second power-supply voltage based on a bias signal and a delay signal;
a plurality of delay elements configured to output the readout signal by delaying a signal of the first node; and
a delay control circuit configured to output the delay signal by delaying the readout signal from the plurality of delay elements.

12. The image sensing device according to claim 11, wherein the drive circuit includes:
a first drive transistor connected between an input terminal of the second power-supply voltage and the first node and configured to receive the bias signal through a gate terminal thereof; and
a second drive transistor connected between the input terminal of the second power-supply voltage and the first node and configured to receive the delay signal through a gate terminal thereof.

13. The image sensing device according to claim 12, wherein:
the first drive transistor becomes turned on according to the bias signal to precharge the first node to a voltage level of the second power-supply voltage,
the drive circuit pulls down the first node to a ground voltage level according to the pixel signal, and
the second drive transistor becomes, after a delay time from the turn-on of the first drive transistor, turned on according to the delay signal to pull up the first node to the voltage level of the second power-supply voltage.

14. The image sensing device according to claim 11, wherein the plurality of delay elements includes:
a first inverter configured to invert the signal of the first node;
a second inverter configured to invert an output signal of the first inverter to output, to the delay control circuit, the inverted signal of the output signal of the first inverter; and
a third inverter configured to invert the output signal of the first inverter to output, as the readout signal, the inverted signal of the output signal of the first inverter.

15. An image sensing device comprising:
a circuit chip; and
a sensor chip stacked on an upper portion of the circuit chip,
wherein the sensor chip includes a plurality of light receiving elements each configured to generate a current pulse by detecting a single photon reflected from a target object, and
wherein the circuit chip includes:
a plurality of quenching circuits corresponding to the plurality of light receiving elements and configured to output a plurality of pixel signals by controlling sensing voltages corresponding to the current pulses, respectively; and
a readout circuit shared by the plurality of quenching circuits and configured to generate a readout signal by reading out the plurality of pixel signals.

16. The image sensing device according to claim 15, wherein:
the plurality of quenching circuits are grouped in units of macro arrays, and
the macro arrays are arranged in rows and columns within the circuit chip.

17. The image sensing device according to claim 15, wherein the readout circuit includes:
a first readout circuit disposed at one side of the circuit chip; and
a second readout circuit disposed at the other side of the circuit chip.

18. The image sensing device according to claim 17, wherein:
each of the first readout circuit and the second readout circuit includes a plurality of macro cells, and
at least one of the macro cells is shared by the plurality of quenching circuits.

19. The image sensing device according to claim 15, wherein the plurality of quenching circuits output the respective pixel signals to a single common node connected to an input terminal of the readout circuit.

20. The image sensing device according to claim 15, wherein the plurality of light receiving elements are connected to the plurality of quenching circuits, respectively.
